(19) United States
(12) Patent Application Publication
(10) Pub. No.: US 2007/0021050 A1
(43) Pub. Date: Jan. 25, 2007

(54) System for providing and managing a laminar flow of clean air

(76) Inventor: Michael Anthony Kennedy, Indianapolis, IN (US)

Correspondence Address: MIKE A. KENNEDY, 2438 NORTH SHADELAND AVENUE, INDIANAPOLIS, IN, 46219, US

(21) Appl. No.: 11/449,200

(22) Filed: Jun. 7, 2006

Related U.S. Application Data
(63) Continuation of application No. 60/691,075, filed on Jun. 16, 2005.

(51) Int. Cl. B01L 1/04

(52) U.S. Cl. 454/187

(57) ABSTRACT

A system for providing and managing a laminar flow of filtered air for a clean room workspace has a blower for blowing air through a filter and over the work area. The velocity of air flowing through the filter is automatically controlled by a feedback loop wherein sensors enable the system to learn of a drop in flow, or even a flow rate that strays above a set point, and to then take action to change settings of the variable frequency drive which, in turn, vary the current to the motors causing a change in blower speed. The system's programmable logic control also provides for automatic recording and storing of data relating to the operating characteristics of the system, including the date and time that the operating characteristics were recorded. The recording may be done in a manner so as not to be editable by the system operator, which makes such record compliant with federal regulations.

### REFERENCE TO RELATED APPLICATIONS

This application claims the benefit of provisional application No. 60/691,075, filed Jun. 16, 2005, which is incorporated herein by reference.

### TECHNICAL FIELD OF THE INVENTION

The invention generally relates to in-door air quality control, and more particularly to a system for providing and managing a laminar flow of filtered air for a clean room workspace.

### BACKGROUND OF THE INVENTION

HEPA or ULPA filtered laminar flow is an aseptic column of air pushing either vertically or horizontally with piston-like precision across the workplace, displacing room-generated particles and process-generated particles and moving them into the air filters for interception. These conditions remain in place workday after workday.

A pharmaceutical clean room may be either a turbulent flow or a laminar flow clean room. In the case of turbulent flow, the particle count is kept at or below acceptance criteria by means of dilution with a known volume of clean air. In the case of a laminar flow clean room, the particle count is controlled by the purity of the air as well as by its unidirectional, or non-turbulent, character.

Laminar flow air may be delivered to the clean room in a number of ways each of which differs in the level of discrete control within the area of interest. The present invention seeks to provide the highest level of discrete control and can do so with all components at or near the area of interest (although some may be dispersed to remote locations as may be required).

The United States Food and Drug Administration and its European counterparts evaluate the level of environmental control proposed for a pharmaceutical manufacturing area and oversee the continuing record of the maintenance of this level of control and of the manufacturing process and area Typically, such manufacturing areas are shut down for a brief period every six months so that testing and subsequent adjustment may be done to the environmental systems. Two of the conditions that are tested are the rates of particulate filter penetration and airflow. If conditions are not found to be in compliance with those upon which the area and process was validated originally, then it is said that breached conditions exist. Steps are taken to bring these conditions back within the established acceptance criteria It sometimes happens that such a breach may prompt a review of the product purity testing that had taken place since the last shut down occurred.

Typically, the date of the occurrence of the breach is not known unless the breach was alarmed for and unless the alarm (non-latching) was witnessed. It may be a matter of concern as to which product batches were manufactured during such breached conditions. In such cases paper records must be referred to and must incorporate subsequent corrective action and test results.

Before the development of the present invention, the following shortcomings in laminar flow unit alarms have been observed: flow alarms not available, motor temperature set point adjustment not available, adjustment of the flow was manual and was done within the internal parameters of the variable frequency motor drive, displays of amperage draw and drive hertz were not continuous, automatic flow adjustment was not available and required that pharmaceutical manufacturing be suspended so that measurements could be made by hand with subsequent manual adjustment of the motor drive and, finally, record keeping was not automatic. The present invention provides remedies for all of these shortcomings.

### SUMMARY OF THE INVENTION

In one embodiment of the present invention there is provided a system for providing and managing a laminar flow of filtered air for a clean room workspace. One embodiment of the system includes: (i) a blower for blowing air through a filter and over a work area, and the blower includes an air intake and an air outlet; (ii) a filter effective for cleaning air passing through the filter; (iii) an air flow meter for directly or indirectly measuring the velocity of air flowing through the filter; and (iv) a programmable logic controller (PLC) for receiving a signal representing the air velocity measured by the meter and for responding to the signal by directly or indirectly causing the blower to increase, decrease, or maintain the flow of air through the filter.

The air flow meter may directly measure the velocity of air flowing through the filter, or it may indirectly measure air velocity by measuring another parameter such as air pressure. The air flow meter may indirectly measure the velocity of air flowing through the filter by measuring air pressure at the blower intake. The air flow meter may be a piezometer.

The system may further include a pressure transmitter for receiving air pressure data from the meter, for converting the air pressure data to an electronic signal proportional to the air pressure, and for transmitting the electronic signal to the programmable logic controller.

The system may further include a variable frequency drive for receiving a signal from the PLC and for altering the current flow to the blower in response to that signal.

Additionally, the system may include means for automatically recording and storing data relating to the operating characteristics of the system, including the date and time that the operating characteristics were recorded. The recording may be done in a manner so as to not be editable by the system operator. The operating characteristics may include one or more of each of the following: air flow, motor temperature, electric current, filter pressure drop, and drive faults. The operating characteristics may be recorded and stored in a programmable logic controller.

One object of the present invention is to provide an improved system for providing and managing a laminar flow of filtered air for a clean room workspace that prevents pharmaceutical drug manufacturing during breached conditions and is capable of automatic record keeping in a format that is compliant with federal regulations. Related objects and advantages of the present invention will be apparent from the following description.

### BRIEF DESCRIPTION OF THE DRAWINGS

FIG. 1 is a partly transparent cutaway perspective view of one embodiment of the present invention.

FIG. 2 is a transparent view of an embodiment of the blower plenum of the present invention, showing fans, air flow meter and the pressure transmitter.

FIG. 3 is another transparent view of an embodiment of the blower plenum of the present invention, illustrating the drop-down electrical panel.

FIG. 4 is a plan elevation view of the electrical sub-panel in diagrammatic form.

FIG. 5 is a block diagram depicting in general terms the operation of the PLC.

FIG. 6 shows the engineer's screen of the control panel.

FIG. 7 shows the “Adjust Setpoints” screen.

FIG. 8 shows the VFD screen of the control panel.

FIG. 9 shows the maintenance log screen.

FIG. 10 shows the set point history log screen of the control panel.

FIG. 11 shows the alarm log screen.

FIG. 12 is an electrical schematic of an embodiment of the present invention.

FIG. 13 is a control schematic for an embodiment of the present invention.

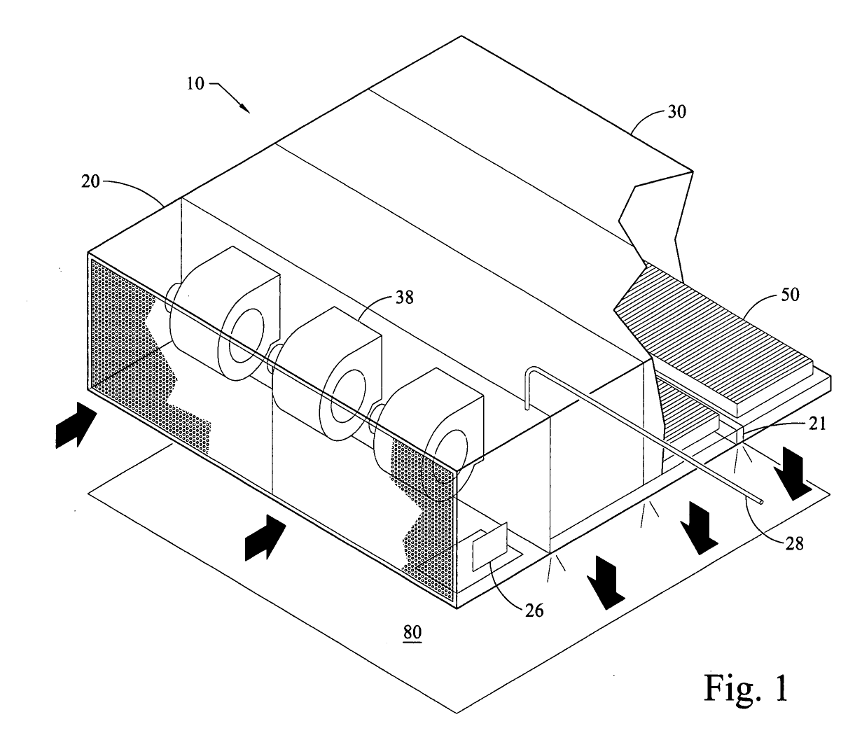

### DESCRIPTION OF THE PREFERRED EMBODIMENT

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

With reference to the figures, one embodiment of Applicant's laminar air system 10, called the Clean Air Continuity Management (CACM) system will be described. The disclosure of the CACM system is not intended to be limiting with respect to the potential application of other aspects of Applicant's invention.

In the preferred embodiment, the system 10 includes a blower plenum 20 and a filter plenum 30 formed from stainless steel and plug welded and polished for a sleek appliance-like appearance. A conduit 28 carries the power to the system 10. The interior of the plenums may be lined with sound insulation, as desired. Perforated stainless steel distribution plates (not shown) may be arranged inside the blower plenum at the fan discharge.

A fan, or blower 38, an airflow meter 40 and a programmable logic controller (PLC) 100 with a control panel 24 are housed within the blower plenum of the CACM system. The blower is effective for blowing air through the filter 50 at a velocity of between 90 feet per second and 150 feet per second. The blower may comprise a plenum fan, or another type of fan. In the preferred embodiment, fan 38 is a centrifugal fan.

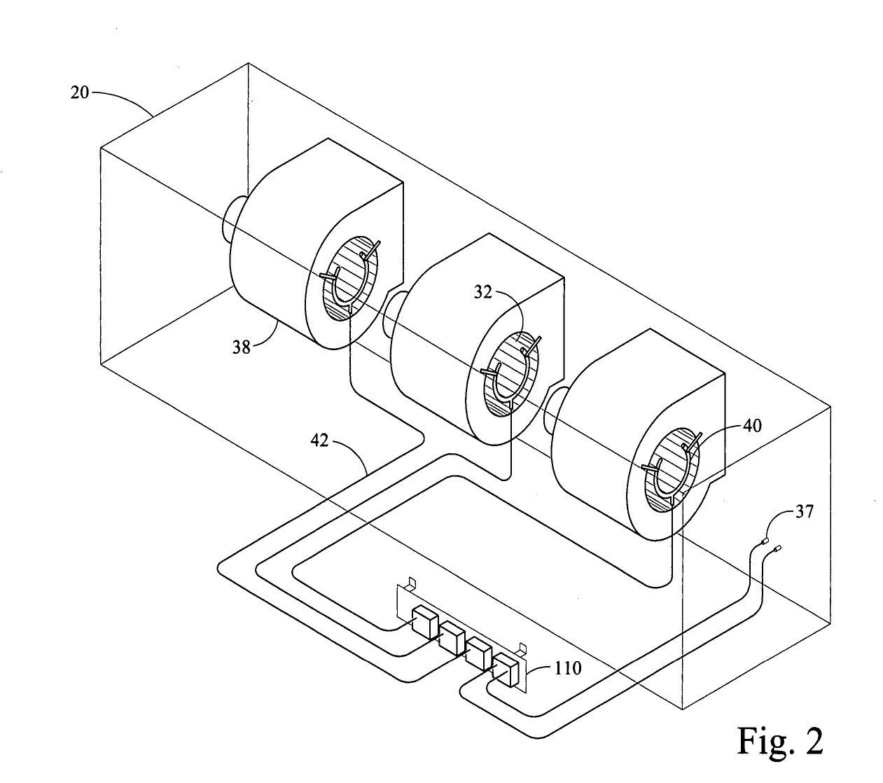

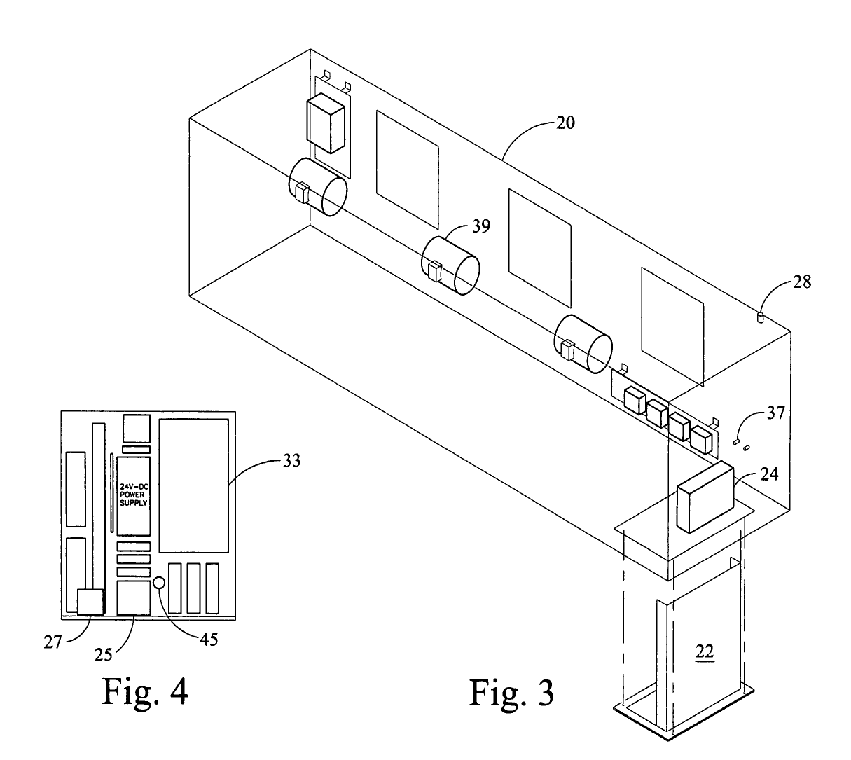

The air flow meter 40 may directly measure the velocity of air flowing through the filter or it may indirectly measure air velocity by measuring another parameter such as air pressure. In the preferred embodiment, the air flow meter indirectly measures the velocity of air flowing through the filter 50 by measuring air pressure at the blower intake. The meter 40 produces a pneumatic signal that is calibrated to by the proportional integral derivative loop in the PLC. In that embodiment, the air flow meter 40 is a piezometer shaped in the form of a partial ring, as shown in FIG. 2, to fit the diameters of the inlets of the blowers, which are custom made. Pneumatic tubing 42 connects the filter plenum 30 and static pressure taps 37 and the piezometers to one or more pressure transmitters 110, which constantly send proportional signals (using milliamps as the unit of measure) to the PLC.

The use of a piezometer for determining the velocity of air flow through the filter has been demonstrated to be effective by lab testing which determined that the pressure changes were repeatable within a narrow profile of values and that the scale range of such values across the expected operating range was sufficiently broad to provide accuracy.

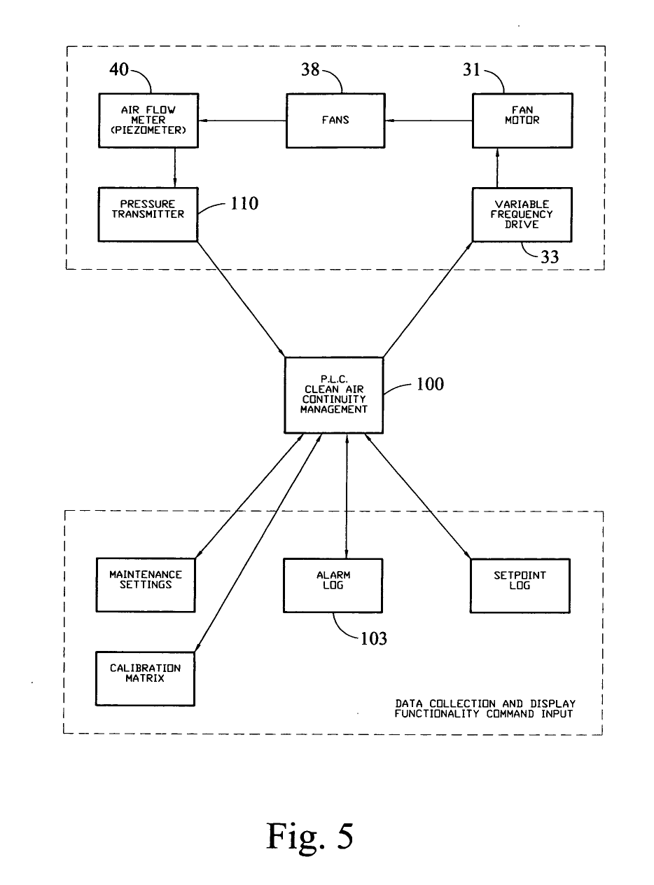

With reference to FIG. 5, the functions of the programmable logic controller 100 are twofold. On the one hand, the PLC serves an internal data collection and display function. On the other hand, the PLC manages the preset operating conditions of the system 10, which include airflow, motor temperature, electric current, filter pressure drop and drive faults. The PLC interfaces with the pressure transmitters 110 and a variable frequency drive (VFD) 33, for example, to automatically control the velocity of air flow from fans 38.

In the preferred embodiment, the CACM control panel 24 provides both manual and automatic modes for airflow control and for the monitoring of the air moving and control systems. Thus, the system 10 may be used not only to automatically record (and date/time stamp) the advent of all alarmed conditions, but also to save histories of maintenance changes and alarm set point changes. In some embodiments, such log entries cannot be deleted nor edited and, for this reason, meet the requirements of federal regulations that govern electronic data.

Inside the filter plenum 30 are filters 50. In one embodiment of the invention, the filter is an ultra low penetration air (ULPA) filter. In the preferred embodiment, the filter is a high efficiency particulate air (HEPA) filter effective for removing 99.99% of all particles 0.3 microns or larger from the air passing through the filter. In a more preferred embodiment, the filter 50 is effective for removing 99.999% of all particles 0.12 microns or larger from the air passing through the filter. In the most preferred embodiment, the filter is effective for removing a greater or lesser amount of all particles of a greater or lesser size, as desired.

In the preferred embodiment, the underside of the plenums includes surface mount lights 21 and easily accessible control switches. A flush-mounted drop-down-access electrical sub-panel 22 shown descended from the bottom of the blower plenum 20 bears most of the controls for the system. Panel 22, as shown diagrammatically in FIG. 4, includes all of the fuses and most of the terminal blocks, including a lockable disconnect switch 25, an audible alarm 45 and a lighted emergency stop button 27.

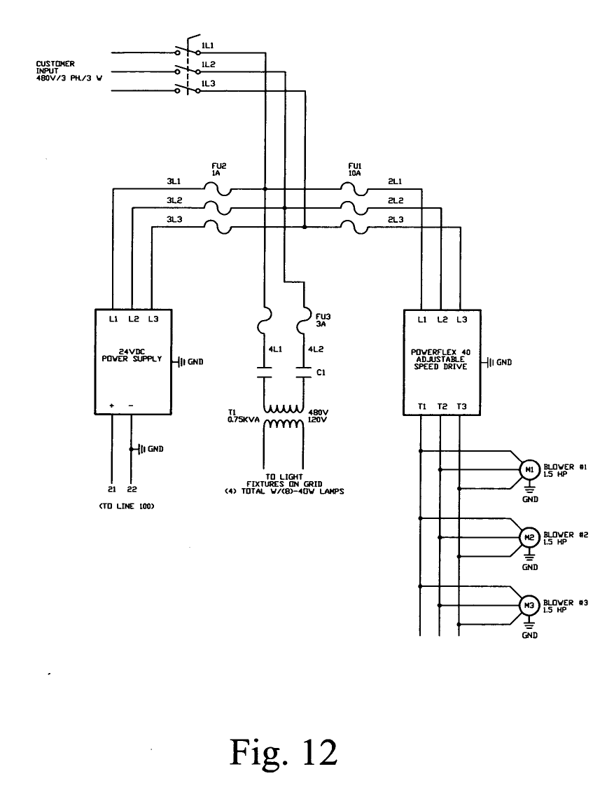

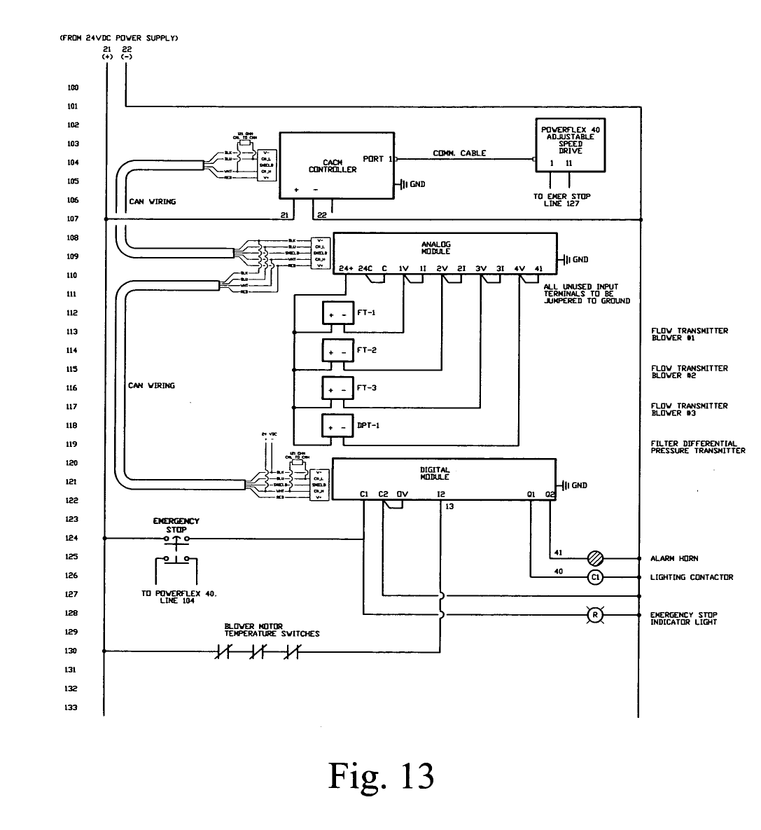

FIG. 12 is an electrical schematic of an embodiment of the present invention, and the control schematic is shown in FIG. 13. The preferred embodiment of system 10 may be designed for a single point 480V power connection with a separate single phase lighting circuit and a 24V DC control circuit.

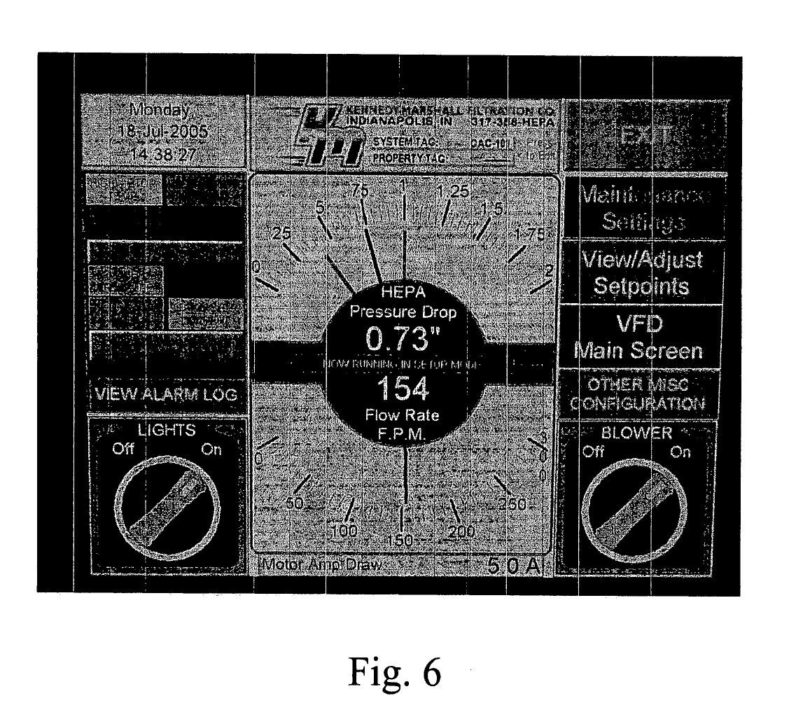

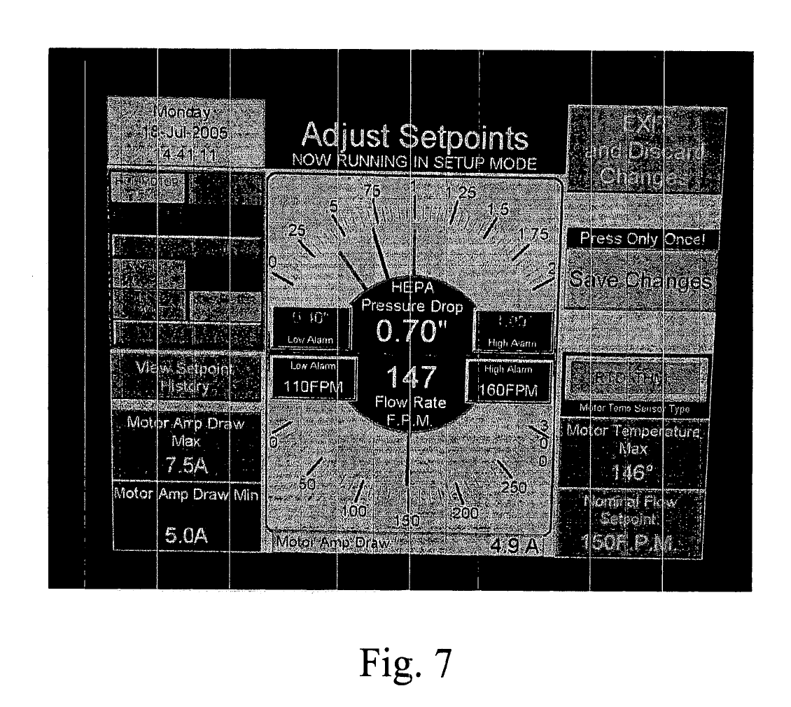

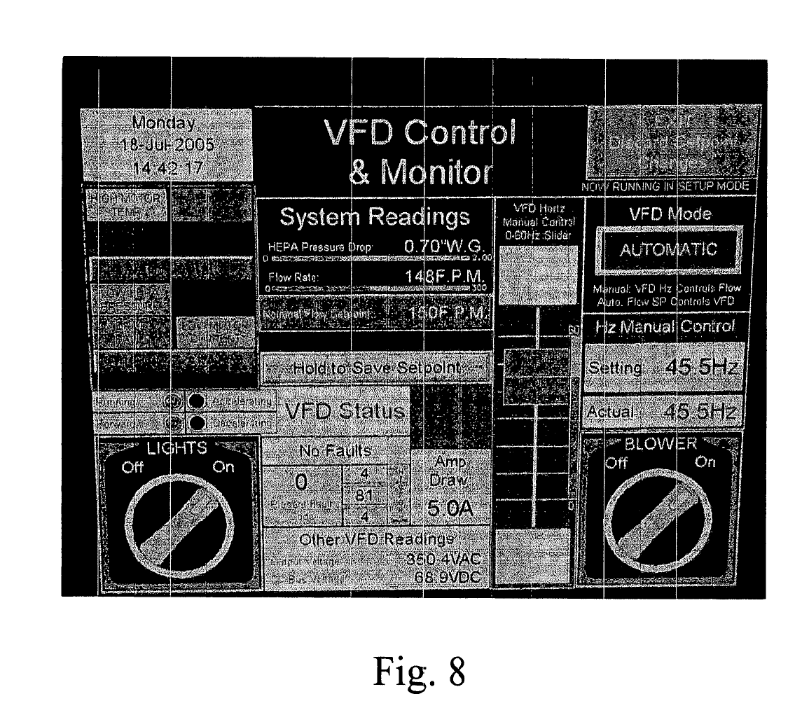

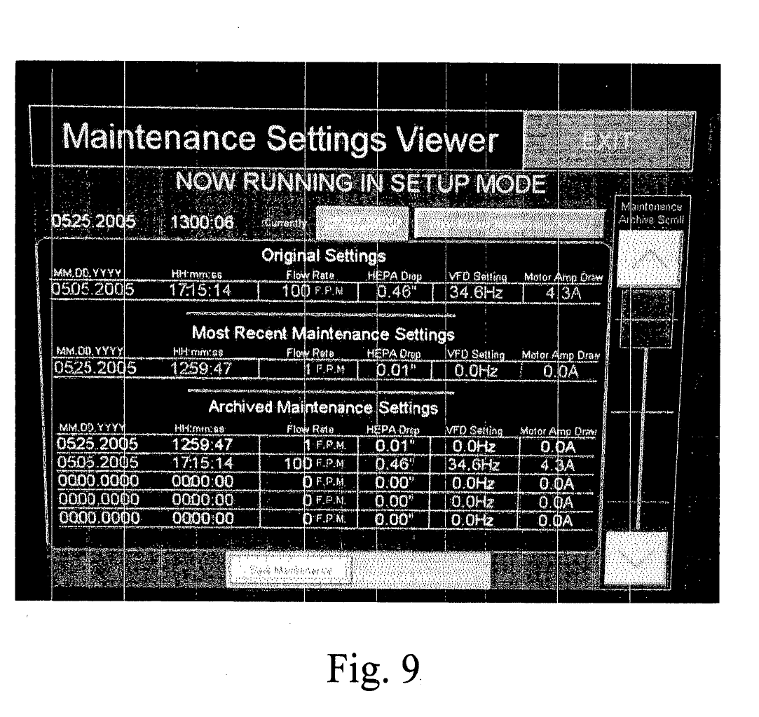

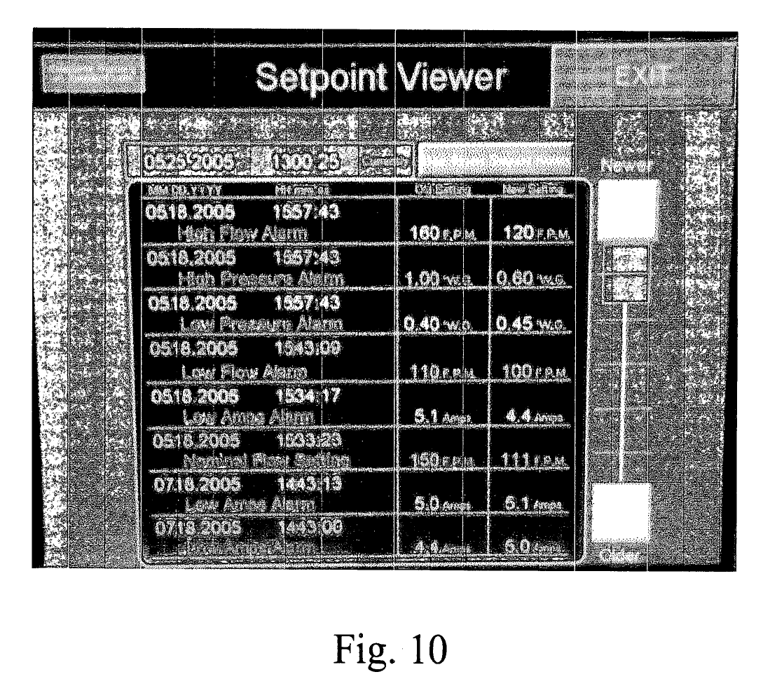

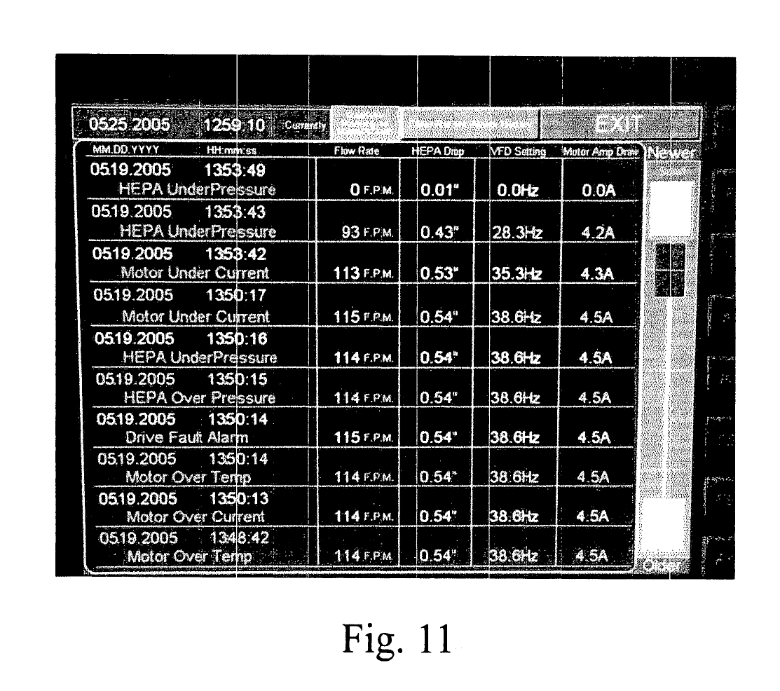

Referring to FIGS. 5-11, to operate the system 10, the operator may provide set points to the PLC via touch screen 26 to tell the system certain desired or maximum/minimum operating parameters such as: the target air flow velocity, the minimum air flow velocity before alarm, the maximum air flow velocity before alarm, the maximum motor temperature before alarm, the minimum current before alarm, the maximum current before alarm, the minimum pressure drop before alarm, the maximum pressure drop before alarm, etc.

The present invention can be used to automatically adjust blower motor speed so as to regain the flow set point. This not only does not require human intervention, it does not require that pharmaceutical manufacturing be halted. The method of such automatic flow control is unique to the present invention. It relies on a “feedback loop” wherein sensors enable the system to learn of a drop in flow (or even a flow rate that strays above set point) and to then take action to change settings of the variable frequency drive, which in turn, vary the current to the motors 39 causing a change in blower speed.

Referring to FIG. 5, the system 10 monitors the operating parameters, and records the conditions, including the date and time, when a breach occurs. The data may be recorded in a manner so as to be permanent and not editable by the system operator.

When a breach in the air flow velocity occurs, the system 10 provides a signal to the variable frequency drive 33. The signal may be proportional to the error in air flow velocity. The VFD 33 may then respond to the signal by adjusting the current flowing to the blower motor 31 such that the blower motor is adjusted to increase or decrease the flow of air through the blower 38.

The flow alarm is non-latching and the audible and visual indicators cease when the alarm condition ceases, but the event is permanently recorded in the alarm log 103.

Whereas the low flow and high flow alarms are only two of the present eight such non-latching alarms used in certain commercial embodiments of the present invention, other embodiments of the invention contemplate alarming for other events, such as particulate penetration levels at the discharges of the filters.

In view of the foregoing, it can be seen that one embodiment of the present invention provides fool-proof record keeping of a pharmaceutical controlled environment that was, hitherto, unavailable with any other laminar flow unit. The present invention may accordingly provide automatic flow control with a unique feedback loop whose primary sensors (such as piezometers) provide the high degree of accuracy and repeatability needed to equal the results hitherto obtained in old-fashioned systems requiring human intervention. It is also unique to the present invention that such automatic intervention in the maintenance of the pharmaceutical controlled environment no longer has to wait for manufacturing shut downs at six-month intervals. The present invention therefore provides the required confidence level of environmental control continuously and without the previous experience of the costly interruption of manufacturing.

While the invention has been illustrated and described in detail in the drawings and foregoing description, the same is to be considered illustrative and not restrictive in character. It is understood that the embodiments have been shown and described in the foregoing specification in satisfaction of the best mode and enablement requirements. It is understood that one of ordinary skill in the art could readily make a nearly infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

1-27. (canceled)

28. A system for monitoring and maintaining a flow of clean air over a work area; said system comprising:
a) a blower for blowing air through a filter and over a work area, said blower having an air intake and an air outlet;
b) a filter effective for cleaning air passing through the filter;
c) an air flow meter for directly or indirectly measuring the velocity of air flowing through the filter; and
d) a programmable logic controller (PLC) for receiving a signal representing the air velocity measured by said meter, and for responding to said signal by directly or indirectly causing said blower to increase, decrease, or maintain the flow of air through the filter.

29. A system according to claim 28, wherein said blower is effective for blowing air through said filter at a velocity of between 90 feet per minute and 150 feet per minute.

30. A system according to claim 28, wherein said blower comprises a centrifugal fan.

31. A system according to claim 28, wherein said blower is contained in a plenum.

32. A system according to claim 28, wherein said filter is effective for removing 99.9% of all particles 0.3 microns or larger from the air passing through the filter.

33. A system according to claim 28, wherein said filter is a high efficiency particulate air (HEPA) filter.

34. A system according to claim 28, wherein said filter is contained in a plenum.

35. A system according to claim 28, wherein said air flow meter indirectly measures the velocity of air flowing through the filter by measuring air pressure at the blower intake.

36. A system according to claim 28, wherein said air flow meter is a piezometer.

37. A system according to claim 28, wherein said system further includes a pressure transmitter for receiving air pressure data from said meter, for converting said air pressure data to an electronic signal proportional to said air pressure, and for transmitting said electronic signal to said programmable logic controller.

38. A system according to claim 28, wherein said system further includes a variable frequency drive for receiving a signal from said PLC and for altering the current flow to said blower in response to that signal.

39. A system according to claim 28, wherein said system further includes means for automatically recording and storing data relating to the operating characteristics of the system, including the date and time that the operating characteristics were recorded, wherein said recording is done in a manner so as not to be editable by the system operator.

40. A system according to claim 39, wherein said operating characteristics include one or more members of the group consisting of: air flow, motor temperature, electric current, filter pressure drop, and drive faults.

41. A system according to claim 39, wherein said operating characteristics are recorded and stored in a programmable logic controller.

42. A method for monitoring and maintaining a flow of clean air across a work area; said method comprising:
a) providing a laminar flow of clean air across a work area by blowing air through a filter;
b) monitoring the flow of air through the filter by using a meter to measure directly or indirectly the velocity of the air flowing through the filter;
c) transmitting an electronic signal proportional to the air velocity measured by the meter to a programmable logic controller;
d) allowing said programmable logic controller to respond to said signal by directly or indirectly causing said blower to increase, decrease, or maintain the flow of air through the filter.

43. A method according to claim 42, wherein air is blown through said filter at a velocity of between 90 feet per minute and 150 feet per minute.

44. A method according to claim 42, wherein said air is blown by a centrifugal fan.

45. A method according to claim 42, wherein said fan is contained in a plenum.

46. A method according to claim 42, wherein said filter is effective for removing 99.9% of all particles 0.3 microns or larger from the air passing through the filter.

47. A method according to claim 42, wherein said filter is a high efficiency particulate air (HEPA) filter.

48. A method according to claim 42, wherein said filter is contained in a plenum.

49. A method according to claim 42, wherein said meter indirectly measures the velocity of air flowing through the filter by measuring air pressure at the blower intake.

50. A method according to claim 42, wherein said meter is a piezometer.

51. A method according to claim 42, wherein said method further includes using a pressure transmitter to convert the air pressure data measured by the meter to an electronic signal proportional to said air pressure.

52. A method according to claim 42, wherein said method further includes using a variable frequency drive to receive a signal from said PLC and to alter the current flow to said blower in response to that signal.

53. A method according to claim 42, wherein said method includes automatically recording and storing data relating to the operating characteristics of the system, including the date and time that the operating characteristics were recorded.

54. A method according to claim 53, wherein said operating characteristics include one or more members of the group consisting of: air flow, motor temperature, electric current, filter pressure drop, and drive faults.
